(19) United States
(12) Patent Application Publication
(10) Pub. No.: US 2010/0119406 A1
(43) Pub. Date: May 13, 2010

(54) ALLYL-CONTAINING PRECURSORS FOR THE DEPOSITION OF METAL-CONTAINING FILMS

(76) Inventors: Christian DUSSARRAT, Wilmington, DE (US); Clement LANSALOT-MATRAS, Tsukuba (JP)

Correspondence Address: AIR LIQUIDE;Intellectual Property, 2700 POST OAK BOULEVARD, SUITE 1800, HOUSTON, TX, 77056, US

(21) Appl. No.: 12/613,732

(22) Filed: Nov. 6, 2009

Related U.S. Application Data
(60) Provisional application No. 61/112,485, filed on Nov. 7, 2008.

(51) Int. Cl. B05D 5/12; C22C 5/04

(52) U.S. Cl. 420/463; 427/125

(57) ABSTRACT

Methods and compositions for depositing a film on one or more substrates include providing a reactor with at least one substrate disposed in the reactor. At least one metal precursor is provided and at least partially deposited on the substrate to form a metal containing film.

### CROSS-REFERENCE TO RELATED APPLICATIONS

The present application claims the benefit of U.S. Provisional Application Ser. No. 61/112,485, filed Nov. 7, 2008, herein incorporated by reference in its entirety for all purposes.

### BACKGROUND

### 1. Field of the Invention

This invention relates generally to compositions, methods and apparatus used for use in the manufacture of semiconductor, photovoltaic, LCF-TFT, or flat panel type devices. More specifically, the invention relates to allyl containing precursors, and their synthesis.

2. Background of the Invention

In the semiconductor industry, there is an ongoing interest in the development of volatile metal precursor for the growth of thin metal films by Chemical Vapor Deposition (“CVD”) and Atomic Layer Deposition (“ALD”) for various applications. CVD and ALD are the main gas phase chemical process used to control deposition at the atomic scale and create extremely thin and conformal coatings. In a typical CVD process, the wafer is exposed to one or more volatile precursors, which react and/or decompose on the substrate surface to produce the desired deposit. ALD process are based on sequential and saturating surface reactions of alternatively applied metal precursor, separated by inert gas purging.

Thin films of palladium or platinum have important applications as electrical contacts (replacing gold which had been used previously), multilayer magneto-optical data storage materials, gas or infrared sensors, multilayer chip capacitor, electrode coating materials, doping agent, catalysts, etc. For instance, Palladium and Platinum are used as doping agents (5-10 at. %) in nickel silicide (NiSi) in source, drain, and gate of CMOS devices in order to improve thermal stability of the silicide. Palladium and platinum overcome the agglomeration though the suppression of NiSi₂ nucleation.

Physical vapor deposition (PVD) such as vacuum sputtering and electroplating have been used a lot in industry to form palladium films, but CVD/ALD techniques would be much preferred for industrialization reasons. The known precursors for Palladium include Pd(η³-allyl)₂ and derivatives such as Pd(η³-CH₂CHCHMe)₂ which have low melting point 20-23° C. but with low decomposition temperature. These are excellent precursors for high-purity palladium thin films by thermal CVD, but they have low thermal stability and are sensitive to both oxygen and moisture. The complex Pd(η³-allyl)Cp has similar physical properties with higher thermal stability, but give films containing carbon impurities. Dimethylpalladium complexes, cis-(PdMe₂L₂) where L=PMe₃ or PEt₃, also give either carbon or phosphorus impurities in the palladium film. The most widely used precursor for palladium films are the beta-diketonato complexes Pd(RC(O)CH(O)CR)₂ where R=Me, CF₃. Mixed complexes Pd(η³-allyl)(diketonate) have also shown to give pure palladium films under mild condition by thermal CVD using either hydrogen or oxygen as co-reactant gas.

Consequently, there exists a need for precursors suitable for deposition via typical CVD and ALD techniques.

### BRIEF SUMMARY

Embodiments of the present invention provide novel methods and compositions useful for the deposition of a film on a substrate. In general, the disclosed compositions and methods utilize a mixed alkyl-(diketonate, enaminoketonate, diketiminate, amidinate or cyclopentadienyl) transition metal precursor. In an embodiment, a method for depositing a film on a substrate comprises providing a reactor with at least one substrate disposed in the reactor. A metal containing precursor is introduced into the reactor, wherein the precursor has the general formula:

L₁-M-L₂

wherein M is a metal selected from among the elements Ni, Ru, Pd, and Pt. L₁ is either a η³ type allyl ligand of the general formula:

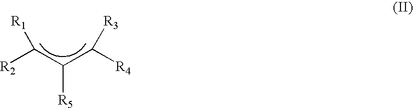

or L₁ is a η³ type cylcopentene ligand of the general formula:

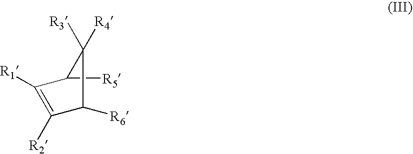

and each of R1, R2, R3, R4, R5, R1′, R2′, R3′, R4′, R5′, and R6′ are independently selected from H, a C1-C5 alkyl group, and Si(R)₃, where R′ is independently selected from H and a C1-C5 alkyl group.

L₂ is either an amidinate or guanidine ligand of the general formula:

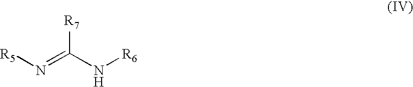

or L₂ is a diketonate ligand of the general formula:

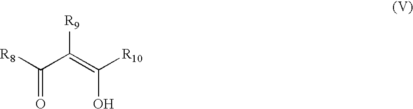

or L₂ is a beta-enaminoketonate ligand of the general formula:

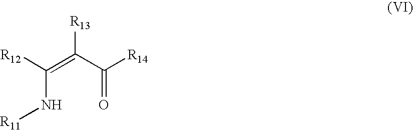

or L₂ is a beta-diketiminate ligand of the general formula:

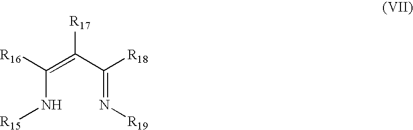

or L₂ is a cyclopentadienyl ligand of the general formula:

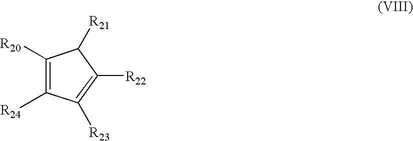

and each of R5, R6, R8, R9, R10, R11, R12, R13, R14, R15, R16, R17, R18, R19, R20, R21, R22, R23, and R24 are independently selected from H, a C1-C5 alkyl group, and Si(R′)₃, where R′ is independently selected from H and a C1-05 alkyl group. R7 is independently selected from H, a C1-C5 alkyl group, and NR′R″, where R′ and R″ are independently selected from the C1-C5 alkyl groups. The reactor is maintained at a temperature of at least about 100° C.; and the precursor is contacted with the substrate to deposit or form a metal containing film on the substrate.

In an embodiment, a metal precursor, which may be a mixed alkyl-(diketonate, enaminoketonate, diketiminate, amidinate, or cyclopentadienyl) transition metal precursor is synthesized through at least one synthesis reaction. The precursor has the general formula:

L₁-M-L₂

wherein M is a metal selected from among the elements Ni, Ru, Pd, and Pt.

L₁ is either a η³ type allyl ligand of the general formula:

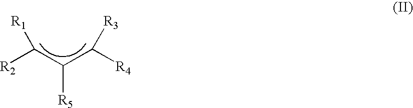

or L₁ is a η³ type cylcopentene ligand of the general formula:

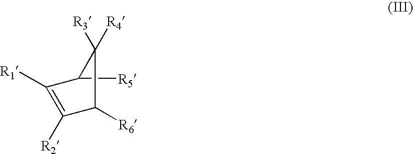

and each of R1, R2, R3, R4, R5, R1′, R2′, R3′, R4′, R5′, and R6′ are independently selected from H, a C1-C5 alkyl group, and Si(R′)₃, where R′ is independently selected from H and a C1-C5 alkyl group.

L₂ is either an amidinate or guanidine ligand of the general formula:

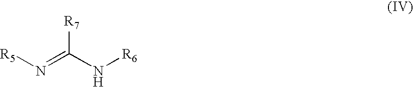

or L₂ is a diketonate ligand of the general formula:

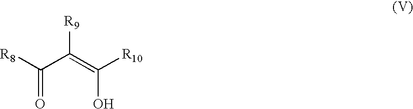

or L₂ is a beta-enaminoketonate ligand of the general formula:

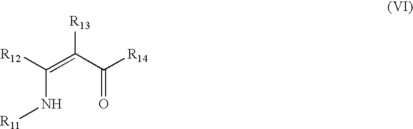

or L₂ is a beta-diketiminate ligand of the general formula:

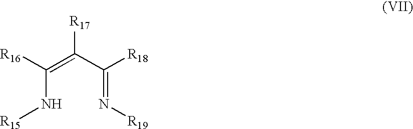

or L₂ is a cyclopentadienyl ligand of the general formula:

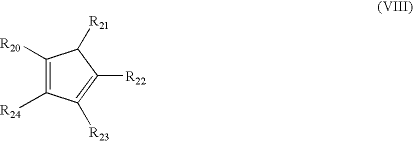

and each of R5, R6, R8, R9, R10, R11, R12, R13, R14, R15, R16, R17, R18, R19, R20, R21, R22, R23, and R24 are independently selected from H, a C1-C5 alkyl group, and Si(R′)₃, where R′ is independently selected from H and a C1-C5 alkyl group. R7 is independently selected from H, a C1-C5 alkyl group, and NR′R″, where R′ and R″ are independently selected from the C1-C5 alkyl groups.

Other embodiments of the current invention may include, without limitation, one or more of the following features:
M is palladium;
L₁ is a cyclopentene ligand of the general formula:

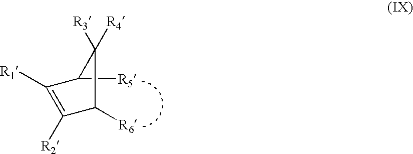

wherein R′₁, R′₂, R′₃, R′₄, R′₅, and R′₆ are independently selected from among: H; a C1-C5 alkyl group; Si(R′)₃, where R′ is independently selected from H, and a C1-C5 alkyl group; and combinations thereof; and wherein R′₅ and R′₆ are bridged such that (—R′₅—R′₆—═—CH₂—CH₂—);
the reactor is maintained at a temperature between about 100° C. and 500° C., and preferably between about 150° C. and 350° C.;
the reactor is maintained at a pressure between about 1 Pa and 10⁵ Pa, and preferably between about 25 Pa and 10³ PA;
a reducing gas is introduced to the reactor, and the reducing gas is reacted with at least part of the precursor, prior to or concurrently with the deposition of at least part of the precursor onto the substrate;
the reducing gas is one of H₂; NH₃; SiH₄; Si₂H₆; Si₃H₈; SiH₂Me₂, SiH₂Et₂, N(SiH₃)₃, hydrogen radicals; and mixtures thereof;
an oxidizing gas is introduced to the reactor, and the oxidizing gas is reacted with at least part of the precursor, prior to or concurrently with the deposition of at least part of the precursor onto the substrate;
the oxidizing gas is one of O₂; O₃; H₂O; NO; carboxylic acid; oxygen radicals; and mixtures thereof;
the deposition process is a chemical vapor deposition (“CVD”) type process or an atomic layer deposition (“ALD”) type process, and either may be plasma enhanced;
the precursor is synthesized according to at least one synthesis scheme;
the precursor can be delivered in neat form or in solvent blend;
the solvent is at least one of ethyl benzene; a xylene; mestiylene; decane; dodecane; and combinations thereof;
a metal containing thin film coated substrate;
the precursor is a palladium containing precursor selected from:
   (η³-allyl)-(4N-methylamino-3-penten-2N-methyliminato) Palladium(II);
   (η³-allyl)-(4N-ethylamino-3-penten-2N-ethyliminato) Palladium(II);
   (η³-allyl)-(4N-npropylamino-3-penten-2N-npropyliminato) Palladium(II);
   (η³-allyl)-(4N-ipropylamino-3-penten-2N-ipropyliminato) Palladium(II);
   (η³-allyl)-(4N-nbuthylamino-3-penten-2N-nbuthyliminato) Palladium(II);
   (η³-allyl)-(4N-ibuthylamino-3-penten-2N-ibuthyliminato) Palladium(II);
   (η³-allyl)-(4N-secbuthylamino-3-penten-2N-secbuthyliminato) Palladium(II);
   (η³-2-methylallyl)-(4N-methylamino-3-penten-2N-methyliminato) Palladium(II);
   (η³-2-methylallyl)-(4N-ethylamino-3-penten-2N-ethyliminato) Palladium(II);
   (η³-2-methylallyl)-(4N-npropylamino-3-penten-2N-npropyliminato) Palladium(II);
   (η³-2-methylallyI)-(4N-ipropylamino-3-penten-2N-ipropyliminato) Palladium(II);
   (η³-2-methylallyl)-(4N-nbuthylamino-3-penten-2N-nbuthyliminato) Palladium(II);
   (η³-2-methylallyl)-(4N-ibuthylamino-3-penten-2N-ibuthyliminato) Palladium(II);
   (η³-2-methylallyI)-(4N-secbuthylamino-3-penten-2N-secbuthyliminato) Palladium(II);
   (η³-1-methylallyl)-(4N-methylamino-3-penten-2N-methyliminato) Palladium(II);
   (η³-1-methylallyl)-(4N-ethylamino-3-penten-2N-ethyliminato) Palladium(II);
   (η³-2-methylallyl)-(4N-npropylamino-3-penten-2N-npropyliminato) Palladium(II);
   (η³-1-methylallyl)-(4N-ipropylamino-3-penten-2N-ipropyliminato) Palladium(II);
   (η³-1-methylallyI)-(4N-nbuthylamino-3-penten-2N-nbuthyliminato) Palladium(II);
   (η³-1-methylallyl)-(4N-ibuthylamino-3-penten-2N-ibuthyliminato) Palladium(II); and
   (η³-1-methylallyl)-(4N-secbuthylamino-3-penten-2N-secbuthyliminato) Palladium(II).

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### Notation and Nomenclature

Certain terms are used throughout the following description and claims to refer to various components and constituents. This document does not intend to distinguish between components that differ in name but not function.

As used herein, the term “alkyl group” refers to saturated functional groups containing exclusively carbon and hydrogen atoms. Further, the term “alkyl group” may refer to linear, branched, or cyclic alkyl groups. Examples of linear alkyl groups include without limitation, methyl groups, ethyl groups, propyl groups, butyl groups, etc. Examples of branched alkyls groups include without limitation, t-butyl. Examples of cyclic alkyl groups include without limitation, cyclopropyl groups, cyclopentyl groups, cyclohexyl groups, etc.

As used herein, the term “allyl ligand” or “allyl group” refers to ligands containing the group allyl (e.g. containing a vinyl group, —CH2=CH—, attached to a methylene —CH2-(-CH2═CH—CH2—)). As used herein, the term “η³-allyl transition metal precursor” refers to a transition metal being coordinated to the 3 carbon atoms of an allyl ligand.

As used herein, the abbreviation, “Me,” refers to a methyl group; the abbreviation, “Et,” refers to an ethyl group; the abbreviation, “n-Bu” or “nBu” refers to the n-butyl group; the abbreviation, “i-Bu” or “iBu” refers to the isobutyl group; the abbreviation, “sec-Bu” or “secBu” refers to the sec-butyl group; the abbreviation, “t-Bu,” or “tBu” refers to a tert-butyl group; the abbreviation, “nPr” refers to the n-propyl group; the abbreviation “iPr”, refers to an isopropyl group; and the abbreviation “Cp” refers to a cyclopentadienyl group.

As used herein, the term “independently” when used in the context of describing R groups should be understood to denote that the subject R group is not only independently selected relative to other R groups bearing the same or different subscripts or superscripts, but is also independently selected relative to any additional species of that same R group. For example in the formula MR¹ₓ(NR²R³)₍₄₋ₓ₎, where x is 2 or 3, the two or three R¹ groups may, but need not be identical to each other or to R² or to R³. Further, it should be understood that unless specifically stated otherwise, values of R groups are independent of each other when used in different formulas.

### DESCRIPTION OF PREFERRED EMBODIMENTS

Embodiments of the present invention provide novel methods and compositions useful for the deposition of a film on a substrate. Methods to synthesize these compositions are also provided. In general, the disclosed compositions and methods utilize a η³-allyl transition metal precursor.

In some embodiments, the transition metal precursor has the general formula:

L₁-M-L₂

wherein M is a transition metal with +2 oxidation state selected from Ni, Ru, Pd, Pt, and preferably M is Pd. L₁ is a η³-ligand selected from amongst allyl ligands, and cyclopentene ligands. In some embodiments the cyclopentene ligand may be bridged (between two of its substitution groups, (i.e. —R—R—═—CH₂—CH₂—). L₂ is a ligand from amongst amidinate ligands, guanidine ligands, diketonate ligands, beta-enaminoketonate ligands, beta-diketiminate ligands, and cylcopentadienyl ligands selected from H, C1-C5 alkyl chain, SiR₃ and their combinations. In some embodiments, the precursor may be one of the precursors listed, and shown schematically, below:
(IX) (η³-allyl)-(4N-methylamino-3-penten-2N-methyliminato) Palladium(II)
(X) (η³-allyl)-(4N-ethylamino-3-penten-2N-ethyliminato) Palladium(II)
(XI) (η³-allyl)-(4N-npropylamino-3-penten-2N-npropyliminato) Palladium(II)
(XII) (η³-allyl)-(4N-ipropylamino-3-penten-2N-ipropyliminato) Palladium(II)
(XIII) (η³-allyl)-(4N-nbuthylamino-3-penten-2N-nbuthyliminato) Palladium(II)
(XIV) (η³-allyl)-(4N-ibuthylamino-3-penten-2N-ibuthyliminato) Palladium(II)
(XV) (η³-allyl)-(4N-secbuthylamino-3-penten-2N-secbuthyliminato) Palladium(II)
(XVI) (η³-2-methylallyl)-(4N-methylamino-3-penten-2N-methyliminato) Palladium(II)
(XVII) (η³-2-methylallyl)-(4N-ethylamino-3-penten-2N-ethyliminato) Palladium(II)
(XVIII) (η³-2-methylallyl)-(4N-npropylamino-3-penten-2N-npropyliminato) Palladium(II)
(XIX) (η³-2-methylallyl)-(4N-ipropylamino-3-penten-2N-ipropyliminato) Palladium(II)
(XX) (η³-2-methylallyl)-(4N-nbuthylamino-3-penten-2N-nbuthyliminato) Palladium(II)
(XXI) (η³-2-methylallyl)-(4N-ibuthylamino-3-penten-2N-ibuthyliminato) Palladium(II)
(XXI I) (η³-2-methylallyl)-(4N-secbuthylamino-3-penten-2N-secbuthyliminato) Palladium(II)
(XXIII) (η³-1-methylallyl)-(4N-methylamino-3-penten-2N-methyliminato) Palladium(II)
(XXIV) (η³-1-methylallyl)-(4N-ethylamino-3-penten-2N-ethyliminato) Palladium(II)
(XXV) (η³-2-methylallyl)-(4N-npropylamino-3-penten-2N-npropyliminato) Palladium(II)
(XXVI) (η³-1-methylallyl)-(4N-ipropylamino-3-penten-2N-ipropyliminato) Palladium(II)
(XXVII) (η³-1-methylallyl)-(4N-nbuthylamino-3-penten-2N-nbuthyliminato) Palladium(II)
(XXVIII) (η³-1-methylallyl)-(4N-ibuthylamino-3-penten-2N-ibuthyliminato) Palladium(II)
(XXIX) (η³-1-methylallyl)-(4N-secbuthylamino-3-penten-2N-secbuthyliminato) Palladium(II)

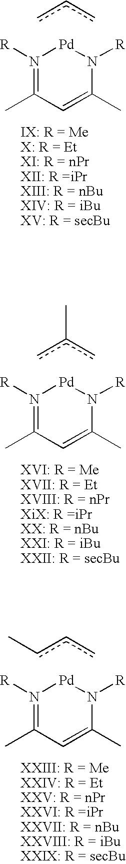

Some embodiments of the present invention describe the synthesis of a transition metal precursor with the general formula:

L₁-M-L₂

wherein M is a transition metal with +2 oxidation state selected from Ni, Ru, Pd, Pt, and preferably M is Pd. L₁ is a η³-ligand selected from amongst allyl ligands, and cyclopentene ligands. In some embodiments the cyclopentene ligand may be bridged (between two of its substitution groups, (i.e. —R—R—=—CH₂—CH₂—). L₂ is a ligand from amongst amidinate ligands, guanidine ligands, diketonate ligands, beta-enaminoketonate ligands, beta-diketiminate ligands, and cylcopentadienyl ligands selected from H, C1-C5 alkyl chain, SiR₃ and their combinations.

In some embodiments, synthesis of these compounds may be carried out according to method A or B:

### Method A:

By reacting MX₂ (where M=Ni, Ru, Pd or Pt and X═Cl, Br or I) with 1 equivalents of Z-L₂ either in first or second step (shown below as Scheme-1) (where Z═Li, Na, K and L₂=amidine, diketonate, enaminoketonate, diketiminate or cyclopentadienyl) and then with L₁-Mg—Br (L₁=allyl or cyclopentene) in either first or second step.

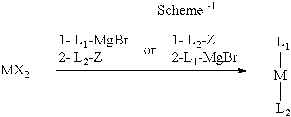

### Method B:

By reacting bis-allyl-palladium-dichloride dimer with 1 equivalents of Z-L₂ (Scheme-2) (where Z═Li, Na, K, TI and L₂=amidine, diketonate, enaminoketonate, diketiminate or cyclopentadienyl)

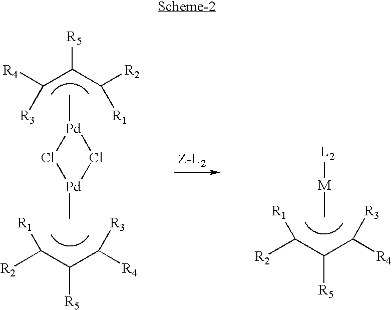

In some embodiments, the precursor can be delivered in neat form or in a blend with a suitable solvent. Suitable solvent is preferably selected from, but without limitation, Ethyl benzene, Xylenes, Mesitylene, Decane, Dodecane in different concentrations.

The disclosed precursors may be deposited to form a thin film using any deposition methods known to those of skill in the art. Examples of suitable deposition methods include without limitation, conventional CVD, low pressure chemical vapor deposition (LPCVD), plasma enhanced chemical vapor depositions (PECVD), atomic layer deposition (ALD), pulsed chemical vapor deposition (P-CVD), plasma enhanced atomic layer deposition (PE-ALD), or combinations thereof.

In an embodiment, the first precursor is introduced into a reactor in vapor form. The precursor in vapor form may be produced by vaporizing a liquid precursor solution, through a conventional vaporization step such as direct vaporization, distillation, or by bubbling an inert gas (e.g. N₂, He, Ar, etc.) into the precursor solution and providing the inert gas plus precursor mixture as a precursor vapor solution to the reactor. Bubbling with an inert gas may also remove any dissolved oxygen present in the precursor solution.

The reactor may be any enclosure or chamber within a device in which deposition methods take place such as without limitation, a cold-wall type reactor, a hot-wall type reactor, a single-wafer reactor, a multi-wafer reactor, or other types of deposition systems under conditions suitable to cause the precursors to react and form the layers.

Generally, the reactor contains one or more substrates on to which the thin films will be deposited. The one or more substrates may be any suitable substrate used in semiconductor, photovoltaic, flat panel, or LCD-TFT device manufacturing. Examples of suitable substrates include without limitation, silicon substrates, silica substrates, silicon nitride substrates, silicon oxy nitride substrates, tungsten substrates, or combinations thereof. Additionally, substrates comprising tungsten or noble metals (e.g. platinum, palladium, rhodium, or gold) may be used. The substrate may also have one or more layers of differing materials already deposited upon it from a previous manufacturing step.

In some embodiments, in addition to the first precursor, a reactant gas may also be introduced into the reactor. In some of these embodiments, the reactant gas may be an oxidizing gas such as one of oxygen, ozone, water, hydrogen peroxide, nitric oxide, nitrogen dioxide, carboxylic acid; radical species of these, as well as mixtures of any two or more of these. In some other of these embodiments, the reactant gas may be a reducing gas such as one of hydrogen, ammonia, a silane (e.g. SiH₄; Si₂H₆; Si₃H₈), SiH₂Me₂; SiH₂Et₂; N(SiH₃)₃; radical species of these, as well as mixtures of any two or more of these.

In some embodiments, and depending on what type of film is desired to be deposited, a second precursor may be introduced into the reactor. The second precursor comprises another metal source, such as copper, praseodymium, manganese, ruthenium, titanium, tantalum, bismuth, zirconium, hafnium, lead, niobium, magnesium, aluminum, lanthanum, or mixtures of these. In embodiments where a second metal containing precursor is utilized, the resultant film deposited on the substrate may contain at least two different metal types.

The first precursor and any optional reactants or precursors may be introduced sequentially (as in ALD) or simultaneously (as in CVD) into the reaction chamber. In some embodiments, the reaction chamber is purged with an inert gas between the introduction of the precursor and the introduction of the reactant. In one embodiment, the reactant and the precursor may be mixed together to form a reactant/precursor mixture, and then introduced to the reactor in mixture form. In some embodiments, the reactant may be treated by a plasma, in order to decompose the reactant into its radical form. In some of these embodiments, the plasma may generally be at a location removed from the reaction chamber, for instance, in a remotely located plasma system. In other embodiments, the plasma may be generated or present within the reactor itself. One of skill in the art would generally recognize methods and apparatus suitable for such plasma treatment.

Depending on the particular process parameters, deposition may take place for a varying length of time. Generally, deposition may be allowed to continue as long as desired or necessary to produce a film with the necessary properties. Typical film thicknesses may vary from several hundred angstroms to several hundreds of microns, depending on the specific deposition process. The deposition process may also be performed as many times as necessary to obtain the desired film.

In some embodiments, the temperature and the pressure within the reactor are held at conditions suitable for ALD or CVD depositions. For instance, the pressure in the reactor may be held between about 1 Pa and about 10⁵ Pa, or preferably between about 25 Pa and 10³ Pa, as required per the deposition parameters. Likewise, the temperature in the reactor may be held between about 100° C. and about 500° C., preferably between about 150° C. and about 350° C.

In some embodiments, the precursor vapor solution and the reaction gas, may be pulsed sequentially or simultaneously (e.g. pulsed CVD) into the reactor. Each pulse of precursor may last for a time period ranging from about 0.01 seconds to about 10 seconds, alternatively from about 0.3 seconds to about 3 seconds, alternatively from about 0.5 seconds to about 2 seconds. In another embodiment, the reaction gas, may also be pulsed into the reactor. In such embodiments, the pulse of each gas may last for a time period ranging from about 0.01 seconds to about 10 seconds, alternatively from about 0.3 seconds to about 3 seconds, alternatively from about 0.5 seconds to about 2 seconds.

### Examples

The following non-limiting examples are provided to further illustrate embodiments of the invention. However, the examples are not intended to be all inclusive and are not intended to limit the scope of the inventions described herein.

### Example 1

### Synthesis of (η³-allyl)-(4N-ethylamino-3-penten-2N-ethyliminato) Palladium(II)

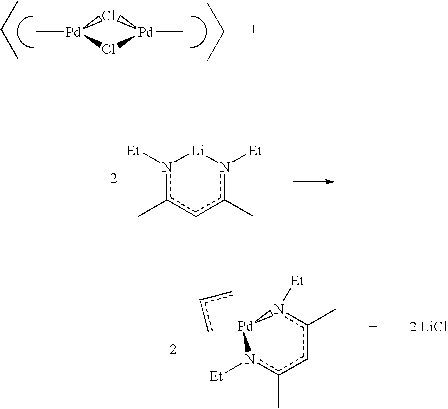

In a 100 mL schlenk flask 2.7 mmol (1.0 g) of palladium allyl chloride dimmer were introduced with diethyl ether (10 mL). To this mixture was added 5.4 mmol of lithium 4N-ethylamino-3-penten-2N-ethyliminato at low temperature (−78° C.), freshly prepared from 4N-ethylamino-3-penten-2N-ethylimine with MeLi in diethyl ether at low temperature (−78° C.). Reaction mixture shifted to darker color and some precipitates were formed (LiCl).

After 1 night at room temperature the mixture was filtered over celite and the solvent removed under vacuum to give a yellow-brown liquid.

It was distillated at 120° C. @20 mTorr to give a yellow liquid, 1.06 g/3.51 mmol/65% yield.

### Example 2

### Synthesis of (η³-allyl)-(4N-isobutylamino-3-penten-2N-isobutyliminato) Palladium(II)

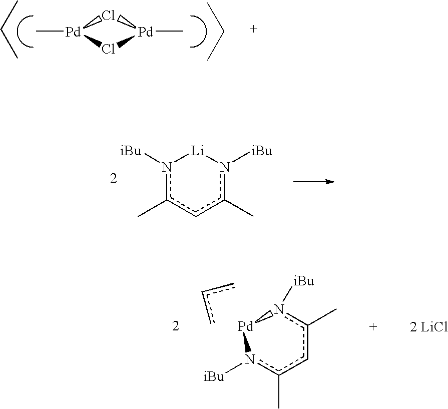

In a 100 mL schlenk flask 2.7 mmol (1.0 g) of palladium allyl chloride dimmer were introduced with diethyl ether (10 mL). To this mixture was added 5.4 mmol of lithium 4N-isobutylamino-3-penten-2N-isobutyliminato at low temperature (−78° C.), freshly prepared from 4N-isobutylamino-3-penten-2N-isobutylimine with MeLi in diethyl ether at low temperature (−78° C.). Reaction mixture shifted to darker color and some precipitate were formed (LiCl). After 1 night at room temperature the mixture was filtered over celite and the solvent removed under vacuum to give a dark yellow liquid.

It was distillated at 130° C. @20 mTorr to give a yellow-green liquid, 1.1 g/3.08 mmol/57% yield.

### Prophetic Example 3

In deposition tests performed using ((η³-allyl)-(4N-ethylamino-3-penten-2N-ethyliminato) Palladium(II) precursors are expected to deposit good films quality, the quality of the film being determined by Auger Electron Spectroscopy (AES). Various substrates could be used, for instance Si and Si with native oxide. LPCVD tests could be performed under Hydrogen or Ammonia atmospheres during 1 hour at different temperatures ranging from 150 to 350 C.

A second set of deposition tests using ((η³-allyl)-(4N-ethylamino-3-penten-2N-ethyliminato) Palladium(II) performed in ALD conditions to grow good films whose quality could be assessed by AES. ALD consist of alternating exposure of the substrate to the vapor of the precursor until saturation, purge the chamber with N₂, expose the substrate to a co-reactant such as Hydrogen, then purge the reactor with a N₂. This sequence cycle could be repeated multiple times at various substrate temperatures (ranging from 150 up to 350 C).

While embodiments of this invention have been shown and described, modifications thereof can be made by one skilled in the art without departing from the spirit or teaching of this invention. The embodiments described herein are exemplary only and not limiting. Many variations and modifications of the composition and method are possible and within the scope of the invention. Accordingly the scope of protection is not limited to the embodiments described herein, but is only limited by the claims which follow, the scope of which shall include all equivalents of the subject matter of the claims.

What is claimed is:

1. A method of forming a metal-containing film on a substrate, comprising:
a) providing a reactor and at least one substrate disposed therein;
b) introducing a metal containing precursor into the reactor, wherein the metal containing precursor comprises a precursor of the general formula:
L₁-M-L₂ (I)
wherein:
1) M is at least one member selected from the group consisting of: Ni, Ru, Pd, and Pt;
2) L₁ is at least one η³ type ligand selected form the group consisting of:
i) an allyl ligand of the general formula: 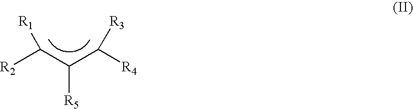
wherein R₁, R2, R3, R4, and R5 are independently selected from among: H; a C1-C5 alkyl group;
Si(R′)₃, where R′ is independently, selected from H, and a C1-C5 alkyl group; and combinations thereof; and
ii) a cyclopentene ligand of the general formula: 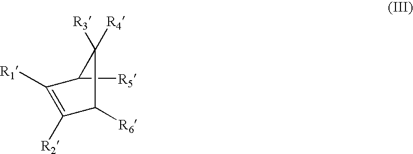
wherein R′₁, R′₂, R′₃, R′₄, R′₅, and R′₆ are independently selected from among: H; a C1-C5 alkyl group; Si(R′)₃, where R′ is independently, selected from H, and a C1-C5 alkyl group; and combinations thereof;
3) L₂ is at least one ligand selected from the group consisting of:
i) an amidinate or guanidine ligand of the general formula: 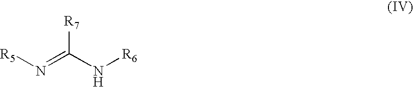
wherein R5 and R6 are independently selected from among: H; a C1-C5 alkyl group; Si(R′)₃, where R′ is independently, selected from H, and a C1-C5 alkyl group; and combinations thereof;
wherein R7 is independently selected from among: H; a C1-C5 alkyl group; and NR′R″, where R′ and R″ are independently selected from the C1-C5 alkyl groups;
ii) a diketonate ligand of the general formula: 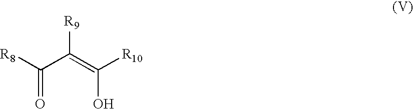
wherein R8, R9, and R10 are independently selected from among: H; a C1-C5 alkyl group; Si(R′)₃, where R′ is independently, selected from H, and a C1-C5 alkyl group; and combinations thereof;
iii) a beta-enaminoketonate ligand of the general formula: 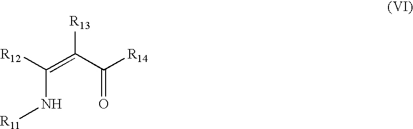
wherein R11, R12, R13 and R14 are independently selected from among: H; a C1-C5 alkyl group; Si(R′)₃, where R′ is independently, selected from H, and a C1-C5 alkyl group; and combinations thereof;
iv) a beta-diketiminate ligand of the general formula: 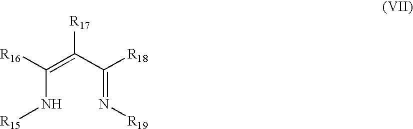
wherein R15, R16, R17, R18 and R19 are independently selected from among: H; a C1-C5 alkyl group; Si(R′)₃, where R′ is independently, selected from H, and a C1-C5 alkyl group; and combinations thereof; and
iv) a cyclopentadienyl ligand of the general formula: 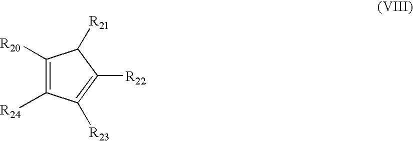
wherein R20, R21, R22, R23 and R4 are independently selected from among: H; a C1-C5 alkyl group; Si(R′)₃, where R′ is independently, selected from H, and a C1-C5 alkyl group; and combinations thereof; and
c) maintaining the reactor at a temperature of at least 100° C.; and
d) contacting the precursor with the substrate to form a metal-containing film.

2. The method of claim 1, wherein L₁ is a cyclopentene ligand of the general formula: 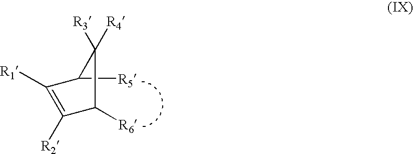
wherein R′₁, R′₂, R′₃, R^{′}₅, and R′₆ are independently selected from among: H; a C1-C5 alkyl group; Si(R)₃, where R′ is independently, selected from H, and a C1-C5 alkyl group; and combinations thereof; and
wherein R′₅ and R′₆ are bridged such that (—R′₅—R′₆═—CH₂—CH₂—).

3. The method of claim 1, wherein M is palladium.

4. The method of claim 1, further comprising maintaining the reactor at a temperature between about 100° C. to about 500° C.

5. The method of claim 4, further comprising maintaining the reactor at a temperature between about 150° C. and about 350° C.

6. The method of claim 1, further comprising maintaining the reactor at a pressure between about 1 Pa and about 10⁵ Pa.

7. The method of claim 6, further comprising maintaining the reactor at a pressure between about 25 Pa and about 10³ Pa.

8. The method of claim 1, further comprising introducing at least one reducing gas into the reactor, wherein the reducing gas comprises at least one member selected from the group consisting of H₂; NH₃; SiH₄; Si₂H₆; Si₃H₈; SiH₂Me₂, SiH₂Et₂, N(SiH₃)₃, hydrogen radicals; and mixtures thereof.

9. The method of claim 8, wherein the metal-containing precursor and the reducing gas are introduced into the chamber substantially simultaneously, and the chamber is configured for chemical vapor deposition.

10. The method of claim 8, wherein the metal-containing precursor and the reducing gas are introduced into the chamber substantially simultaneously, and the chamber is configured for plasma enhanced chemical vapor deposition.

11. The method of claim 8, wherein the metal-containing precursor and the reducing gas are introduced into the chamber sequentially, and the chamber is configured for atomic layer deposition.

12. The method of claim 8, wherein the metal-containing precursor and the reducing gas are introduced into the chamber sequentially, and the chamber is configured for plasma enhanced atomic layer deposition.

13. The method of claim 1, further comprising introducing at least one oxidizing gas into the reactor, wherein the oxidizing gas comprises at least one member selected from the group consisting of: O₂; O₃; H₂O; NO; carboxylic acid; oxygen radicals; and mixtures thereof.

14. The method of claim 13, wherein the metal-containing precursor and the oxidizing gas are introduced into the chamber substantially simultaneously, and the chamber is configured for chemical vapor deposition.

15. The method of claim 13, wherein the metal-containing precursor and the oxidizing gas are introduced into the chamber substantially simultaneously, and the chamber is configured for plasma enhanced chemical vapor deposition.

16. The method of claim 13, wherein the first metal-containing precursor and the oxidizing gas are introduced into the chamber sequentially, and the chamber is configured for atomic layer deposition.

17. The method of claim 13, wherein the first metal-containing precursor and the oxidizing gas are introduced into the chamber sequentially, and the chamber is configured for plasma enhanced atomic layer deposition.

18. The method of claim 1, wherein the wherein the precursor comprises at least one member selected from the group consisting of:
(η³-allyl)-(4N-methylamino-3-penten-2N-methyliminato) Palladium(II);
(η³-allyl)-(4N-ethylamino-3-penten-2N-ethyliminato) Palladium(II);
(η³-allyl)-(4N-npropylamino-3-penten-2N-npropyliminato) Palladium(II);
(η³-allyl)-(4N-ipropylamino-3-penten-2N-ipropyliminato) Palladium(II);
(η^{a}-allyl)-(4N-nbuthylamino-3-penten-2N-nbuthyliminato) Palladium(II);
(η³-allyl)-(4N-ibuthylamino-3-penten-2N-ibuthyliminato) Palladium(II);
(η³-allyl)-(4N-secbuthylarnino-3-penten-2N-secbuthyliminato) Palladium(II);
(η³-2-methylallyl)-(4N-methylamino-3-penten-2N-methyliminato) Palladium(II);
(η³-2-methylallyl)-(4N-ethylamino-3-penten-2N-ethyliminato) Palladium(II);
(η³-2-methylallyl)-(4N-npropylamino-3-penten-2N-npropyliminato) Palladium(II);
(η³-2-methylallyl)-(4N-ipropylamino-3-penten-2N-ipropyliminato) Palladium(II);
(η³-2-methylallyl)-(4N-nbuthylamino-3-penten-2N-nbuthyliminato) Palladium(II);
(η³-2-methylallyl)-(4N-ibuthylamino-3-penten-2N-ibuthyliminato) Palladium(II);
(η³-2-methylallyl)-(4N-secbuthylamino-3-penten-2N-secbuthyliminato) Palladium(II);
(η³-1-methylallyl)-(4N-methylamino-3-penten-2N-methyliminato) Palladium(II);
(η³-1-methylallyl)-(4N-ethylamino-3-penten-2N-ethyliminato) Palladium(II);
(η³-2-methylallyl)-(4N-npropylamino-3-penten-2N-npropyliminato) Palladium(II);
(η³-1-methylallyl)-(4N-ipropylamino-3-penten-2N-ipropyliminato) Palladium(II);
(η³-1-methylallyl)-(4N-nbuthylamino-3-penten-2N-nbuthyliminato) Palladium(II);
(η³-1-methylallyl)-(4N-ibuthylamino-3-penten-2N-ibuthyliminato) Palladium(II); and
(η³-1-methylallyl)-(4N-secbuthylamino-3-penten-2N-secbuthyliminato) Palladium(II).

19. A metal containing thin film coated substrate comprising the product of the method of claim 1.
